(19) United States
(12) Patent Application Publication
(10) Pub. No.: US 2003/0163517 A1
(43) Pub. Date: Aug. 28, 2003

(54) Method and apparatus for decreasing bandwidth for wireless data interchange

(76) Inventors: Charles S. Assaf, Outremont (CA); Richard St-Cyr, St-Hubert (CA); Arkadev Chattopadhyay, Longueuil (CA)

Correspondence Address: ROSENTHAL & OSHA L.L.P., 1221 MCKINNEY AVENUE, SUITE 2800, HOUSTON, TX, 77010, US

(21) Appl. No.: 10/135,707

(22) Filed: Apr. 30, 2002

Related U.S. Application Data
(60) Provisional application No. 60/360,201, filed on Feb. 28, 2002.

(51) Int. Cl. G06F 15/16

(52) U.S. Cl. 709/203

(57) ABSTRACT

A method for optimizing wireless data interchange, including receiving a request for a view, retrieving a data package corresponding to the view, transmitting the data package to a wireless client, determining if a template corresponding to the view is located on the wireless client, retrieving the template if the template is located on the wireless client, and rendering the view on the wireless client using the data package and the template.

### CROSS-REFERENCE TO RELATED APPLICATIONS

This application claims benefit of U.S. Provisional Application Serial No. 60/360,201 filed on Feb. 28, 2002, entitled “Method and Apparatus for Decreasing Bandwidth for Wireless Data Interchange”, in the names of Charles S. Assaf, Richard St-Cyr, and Arkadev Chattopadhyay.

### BACKGROUND OF INVENTION

Mobile professionals, e.g., professionals that travel on business, require a convenient means to access information while away from the office. The information that typically has the greatest demand is contained in applications that handle e-mail, scheduling, etc. To meet this demand, mobile professionals are increasingly using wireless devices, e.g., Personal Digital Assistants (PDA) with wireless capabilities, web-enabled cellular phones, etc., to provide the link between themselves and the applications located in the office.

Wireless devices typically employ either a “pull” framework or “push” framework to connect to the office. Both technologies are based on a client/server model, where the client is a wireless device and the server is a computer located at the office. The server usually is connected to the Internet or other Wide Area Networks (WANs). Typically, one computer in the model is a wireless application server, e.g., a server that controls data transfer to and from a wireless device.

FIG. 1 illustrates a typical layout of a client/server model employing a “pull” framework. When employing a “pull” framework, a client (20) sends a request (26) for information to a server (22). For example, the client (20) may request a web page by sending a Universal Resource Locator (URL) to the server (22). The server (22) responds to the request by sending the web page (24) corresponding to the URL back to the client (20). In this model, the client (20) is said to “pull” information from the server (22).

FIG. 2 illustrates a typical layout of a client/server model employing a “push” framework. In contrast to the “pull” framework, when employing a “push” framework, the client (20) does not explicitly request information from the server (22). Rather, the server (22) sends information (28) to the client (20) based on events triggered within the server (22), e.g., a new e-mail message, a change in the calendar, etc. In this model, the server (22) is said to “push” information on to the client (20).

Wireless devices send and receive data based on a wireless protocol, such as the Wireless Application Protocol (WAP (see http://www.wapforum.org/). WAP is a protocol that defines an industry-wide specification for developing applications that operate over wireless communication networks. The following discussion of WAP is based on the WAP protocol specification. Implementations using WAP may not be 100% WAP compliant or rely solely on the functionality provided by WAP.

The “pull” framework is typically used by a wireless client to obtain information from a server. A common example is a wireless client performing a simple Directory Inquiry for a telephone number in a database. The wireless client first requests a web page by sending a Universe Resource Locator (URL) to the server. The server responds with a Directory Inquiry web page. The Directory Inquiry web page contains an input parameter, “name”, to allow the user of the wireless client to input a name of a person, for example, for which a phone number is being requested. The Directory Inquiry web page is submitted using an Hypertext Mark-up Language (HTML) POST method that includes the input parameters as a request for a second URL from the server. The response from the server contains of a formatted web page that includes the information requested and the output parameter(s) (the telephone number in this case).Altematively, the web page may indicate that the input parameter was not found or is invalid.

Typically, the response web page to a request includes dynamic content and static content. Further, the response web page is typically generated on the server prior to being sent to the wireless client. The static content includes content that does not change for different requests. Referring to the previous example, the static content would potentially include the layout of the response web page from the server and the background color of the response web page. In contrast, the dynamic content is content that is different for every request. Referring to the previous example, the dynamic content would be the retrieved telephone number.

An HTML-based request for a simple Directory Inquiry, as described in the previous example, is approximately 7,000 bytes. The response is also approximately 7,000 bytes. A potential reduction in bandwidth may be possible through a separation of dynamic content and static content, and partial generation of web pages on the wireless client.

### SUMMARY OF INVENTION

In general, in one aspect, the invention relates to a system for optimizing wireless data interchange, comprising a wireless client, an enterprise server arranged to provide a dynamic content and a template to the wireless client, a business logic layer arranged to request the dynamic content from the enterprise server, a template cache storing the template, and a rendering engine configured to generate a view using the template and the dynamic content, wherein the business logic layer, the template cache, and the rendering engine are located on the wireless client.

In general, in one aspect, the invention relates to a system for optimizing wireless data interchange, comprising a wireless client, an enterprise server arranged to provide a dynamic content and a template to the wireless client, a business logic layer arranged to request the dynamic content from the enterprise server, a template cache storing the template, a rendering engine configured to generate a view using the template and the dynamic content, and a transport layer providing communication services between the enterprise server and the wireless client, wherein the business logic layer, the template cache, the rendering engine, and the transport layer are located on the wireless client.

In general, in one aspect, the invention relates to a wireless client for optimizing wireless data interchange, comprising a business logic layer arranged to request the dynamic content from an enterprise server, a template cache storing the template, a rendering engine configured to generate a view using the template and the dynamic content, and a transport layer providing communication services between the enterprise server and the wireless client.

In general, in one aspect, the invention relates to a method for optimizing wireless data interchange, comprising receiving a request for a view, retrieving a data package corresponding to the view, transmitting the data package to a wireless client, determining if a template corresponding to the view is located on the wireless client, retrieving the template if the template is located on the wireless client, and rendering the view on the wireless client using the data package and the template.

In general, in one aspect, the invention relates to a method for optimizing wireless data interchange, comprising receiving a request for a view, retrieving a data package corresponding to the view, transmitting the data package to a wireless client, determining if a template corresponding to the view is located on the wireless client, retrieving the template if the template is located on the wireless client, rendering the view on the wireless client using the data package and the template, issuing an update request for the template if the template is not present on the wireless client, receiving a response to the update request producing an updated template, and storing the updated template on the wireless client.

In general, in one aspect, the invention relates to an apparatus for optimizing wireless data interchange, comprising means for receiving a request for a view, means for retrieving a data package corresponding to the view, means for transmitting the data package to a wireless client, means for determining if a template corresponding to the view is located on the wireless client, means for retrieving the template if the template is located on the wireless client, and means for rendering the view on the wireless client using the data package and the template.

In general, in one aspect, the invention relates to an apparatus for optimizing wireless data interchange, comprising means for receiving a request for a view, means for retrieving a data package corresponding to the view, means for transmitting the data package to a wireless client, means for determining if a template corresponding to the view is located on the wireless client, means for retrieving the template if the template is located on the wireless client, means for rendering the view on the wireless client using the data package and the template, means for issuing an update request for the template if the template is not present on the wireless client, means for receiving a response to the update request producing an updated template, and means for storing the updated template on the wireless client.

Other aspects and advantages of the invention will be apparent from the following description and the appended claims.

### BRIEF DESCRIPTION OF DRAWINGS

FIG. 1 illustrates a pull framework operating over a client/server model.

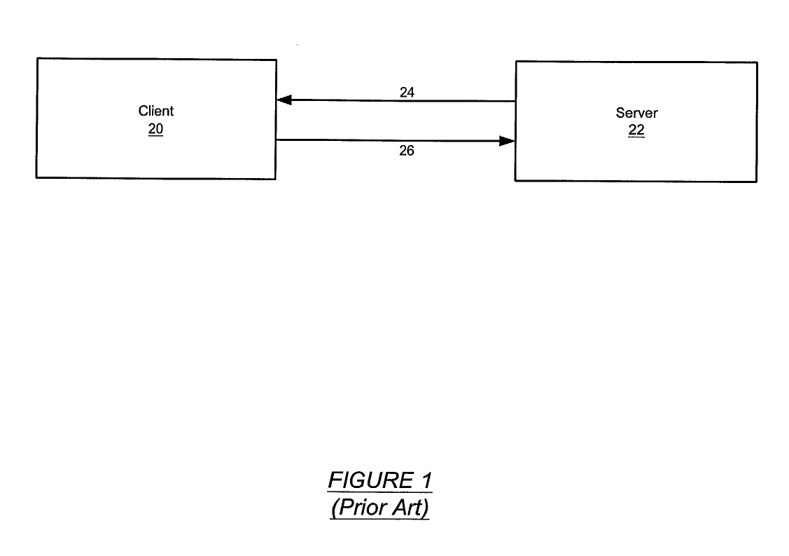

FIG. 2 illustrates a push framework operating over a client/server model.

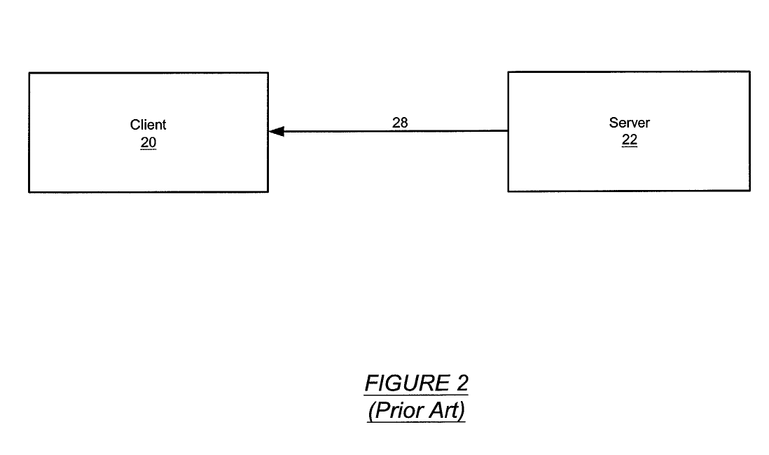

FIG. 3 illustrates an enterprise system in accordance with one embodiment of the invention.

FIG. 4 illustrates, in flowchart form, a method for decreasing bandwidth for wireless data interchange between a wireless client and a server in accordance with one embodiment of the invention.

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The invention relates to a method for decreasing bandwidth for wireless data interchange. Further, the invention relates to a method for separating dynamic content and static content to decrease bandwidth for wireless data interchange. Further, the invention relates to a method for partially generating the response on a wireless client.

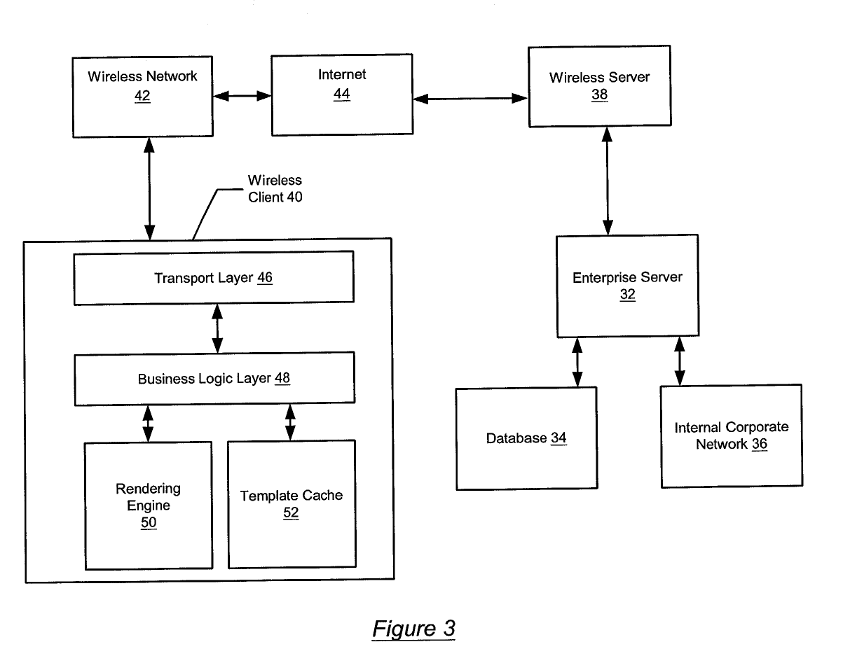

FIG. 3 illustrates an enterprise system in accordance with one embodiment of the invention. An enterprise system typically includes an enterprise server (32) connected to various resources, such as a database (34). The enterprise server (32) is also connected to an internal corporate network (36), including desktop computers, networked printers, etc. The enterprise server (32) provides access to the Internet (44) for all resources operatively connected to it. To provide wireless services, the enterprise system also typically includes a wireless application server (38) that manages data flow to wireless clients (40), e.g., PDA's with wireless capability, via a wireless network (42).

In one embodiment of the invention, the wireless client (40) includes a transport layer (46), a business logic layer (48), a rendering engine (50), and a template cache (52). The transport layer (46) provides communication services to allow the wireless client (40) to communicate with the enterprise server (32). In one embodiment of the invention, the transport layer (46) is WAP compliant.

The template cache (52) contains templates used in the generation of the response web page on the wireless client (40). Specifically, the templates are representations of the formatting that is to be displayed to a wireless client user. In one embodiment of the invention, each template includes a template version number that identifies the version of the template. This allows the wireless client (40) to track updates to the templates, and to determine if a given template residing in the template cache (52) is the most current version of the template. Further, in one embodiment of the invention, the template is defined using Extensible Stylesheet Language (XSL).

In one embodiment of the invention, the template describes “Text Fields”, “Bitmap Images”, “Input Fields”, and “Activators” that may be displayed on the screen of a device. Activators can include links (in the form of a button displayed on the screen), physical buttons (these can vary from device type to device type), hyperlinks, menu items, etc. Activators may also specify an action to be performed, such as “submit” data to the server, request the display of a different web page, request the execution of a script function or application on the device (such the Address Book or the Web Browser), etc.

In one embodiment of the invention, the template cache (52) is implemented as a flat-file structure. In another embodiment of the invention, the template cache (52) is implemented as a hash table.

The business logic layer (48) manages communication between the various components within the wireless client (40). Further, the business logic layer (48) generates and forwards requests for a web page, via the transport layer (46), to the enterprise server (32). Additionally, the business logic layer (48) receives data packages in response to requests to the enterprise server (32) via the transport layer (46). In one embodiment of the invention, the data package includes dynamic content and a web page identifier. The dynamic content corresponds to the dynamic portion of the web page that is to be displayed to the wireless client user. The web page identifier is a representation that uniquely identifies a web page and its version number. In one embodiment of the invention, the web page identifier includes a web page version number that corresponds to the version the web page template that is to be used to generate the response web page.

Further, the business logic layer (48) determines if the necessary template(s) is/are present in the template cache (52). If the necessary template(s) is/are not present in the template cache (52), then the business logic layer (48) sends an update request to obtain the most current version of the template from the enterprise server (32). If the necessary template(s) is/are found in the template cache (52), the business logic layer (48) forwards them to the rendering engine (50), along with the dynamic content from the data package. In one embodiment of the invention, the dynamic content is defined using Extensible Mark-up Language (XML).

The rendering engine (50) uses the dynamic content and the corresponding template(s) as input to generate the web page. In one embodiment of the invention, the rendering engine is an XSL Transformation processor that takes dynamic content in the form of XML documents, or templates in the form of XSL documents, and generates HTML documents that may be displayed by web-browser software (not shown) running on the wireless client.

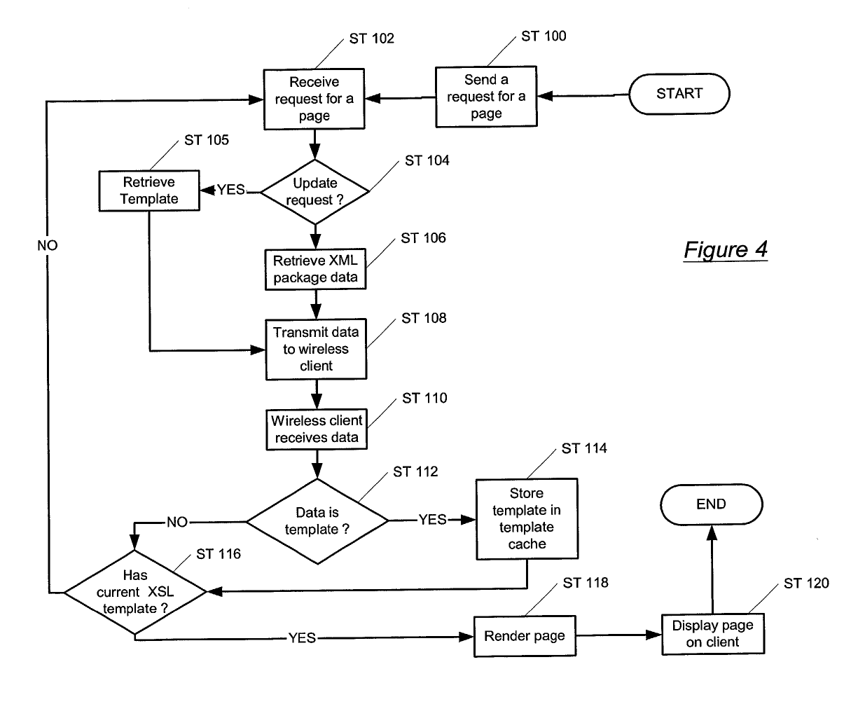

FIG. 4 illustrates, in flowchart form, a method for decreasing bandwidth for wireless data interchange between a wireless client and a server, in accordance with one embodiment of the invention. A business logic layer, residing on a wireless client, sends a request to an enterprise server (Step 100). The enterprise server receives the request (Step 102). The enterprise server checks to see if the request is for a template, i.e., an update request (Step 104). If the request is for a template, then the corresponding template is retrieved (Step 105) and the process proceeds to step 108. If the request is not for an update request, i.e., the request is for dynamic content, the enterprise server retrieves a data package (Step 106). The data package or the template is optionally processed prior to being transmitted to the wireless client (Step 108). For example, the data package may be signed, encrypted, compressed, etc.

The wireless client receives the web page and optionally processes the data package depending on the received format of the data package, e.g., if the data package was encrypted then the wireless client will have to decrypt the data package (Step 110). If the data received by the wireless client is a template (Step 112), the template is stored in the template cache (Step 114). In one embodiment of the invention, only the most recent version of the template is stored in the template cache.

If the data is not a template (Step 112), i.e., the data is a data package, the wireless client proceeds to check if the template, referenced within the package data, is available in the template cache (Step 116). In one embodiment of the invention, the web page identifier is used to determine if a given template is present in the template cache. If a template corresponding to the web page identifier is not found, the wireless client issues an update request and proceeds to Step 102. Two typical situations that result in the generation and issuing of an update request are: (i) if this is the first time a given template was requested, or (ii) if the template was modified to produce a new version.

If the corresponding template is found in the template cache, or once the corresponding template is retrieved from the enterprise server via an update request, the wireless client takes the data package and the corresponding template and renders the web page (Step 118). The web page is subsequently displayed on the wireless client (Step 120).

In one embodiment of the invention, a wireless client using the method described above for a typical directory inquiry typically uses approximately 10,000 bytes for sending an initial directory inquiry web page. However, this is only required a single time as subsequent requests for this web page result in accesses to the web page from a cache stored in non-volatile memory on the wireless client. Further, the response web page is approximately 14,000 bytes the first time the response web page is displayed, and approximately 700 bytes each time thereafter.

Those skilled in the art will appreciate that while the above discussion describes the invention in the context of sending and retrieving requests for particular web pages, the invention is not limited to only this embodiment. For example, the invention may be used with a proprietary distributed application. In addition, the invention as described above may be used in any application where static and dynamic content may be separated, for example, when using a wireless-based instant messenger program, the background images and layout would be static content and the dynamic content would be messages being sent and received.

Further, while the term “web page” was used to describe the invention, those skilled in the art will appreciate that the term “web page” may be extended to any human readable form on a wireless client. Thus, if the invention was used with a remote wireless application that was not web based, then the content viewed by the wireless user would be described as view, i.e., a particular screen within the application, such as a login screen.

Advantages of the present invention may include one or more of the following. The invention separates the dynamic and static content for each web page being requested by the wireless client thereby necessitating only the re-sending of dynamic content for subsequent requests. This provides a substantial decrease in the bandwidth usage. Further, the invention allows the response web page to be generated by the wireless client thereby offsetting or decreasing the CPU usage on the enterprise server. Further, the invention can be used with existing enterprise systems with only slight modifications to the wireless clients and the enterprise server. Those skilled in the art can appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for optimizing wireless data interchange, comprising:
a wireless client;
an enterprise server arranged to provide a dynamic content and a template to the wireless client;
a business logic layer arranged to request the dynamic content from the enterprise server;
a template cache storing the template; and
a rendering engine configured to generate a view using the template and the dynamic content,
wherein the business logic layer, the template cache, and the rendering engine are located on the wireless client.

2. The system of claim 1, further comprising:
a transport layer providing communication services between the enterprise server and the wireless client, wherein the transport layer is located on the wireless client.

3. The system of claim 1, wherein the dynamic content comprises an extensible mark-up language document.

4. The system of claim 1, wherein the template comprises an extensible stylesheet language document.

5. The system of claim 1, wherein the rendering engine comprises an extensible stylesheet language transformation processor.

6. The system of claim 1, wherein the transport layer is wireless application protocol compliant.

7. The system of claim 1, wherein the dynamic content comprises an extensible mark-up language document corresponding to the view, and a view identifier corresponding to the view.

8. The system of claim 7, wherein the view identifier comprises a numerical representation that uniquely identifies the view.

9. The system of claim 8, wherein the view identifier further comprises a view version number.

10. The system of claim 1, wherein the template comprises a template version number.

11. The system of claim 1, wherein the business logic layer extracts information from the wireless client to generate a request for dynamic content.

12. The system of claim 1, wherein the template cache comprises a flat-file data structure.

13. The system of claim 1, wherein the template cache comprises a hash table.

14. The system of claim 1, wherein the view corresponds to a particular screen in a distributed application running on the enterprise server.

15. The system of claim 1, wherein the view is a web view.

16. A system for optimizing wireless data interchange, comprising:
a wireless client;
an enterprise server arranged to provide a dynamic content and a template to the wireless client;
a business logic layer arranged to request the dynamic content from the enterprise server;
a template cache storing the template;
a rendering engine configured to generate a view using the template and the dynamic content; and
a transport layer providing communication services between the enterprise server and the wireless client,
wherein the business logic layer, the template cache, the rendering engine, and the transport layer are located on the wireless client.

17. A wireless client for optimizing wireless data interchange, comprising:
a business logic layer arranged to request the dynamic content from an enterprise server;
a template cache storing the template;
a rendering engine configured to generate a view using the template and the dynamic content; and
a transport layer providing communication services between the enterprise server and the wireless client.

18. The system of claim 17, wherein the dynamic content comprises an extensible mark-up language document.

19. The system of claim 17, wherein the template comprises an extensible stylesheet language document.

20. The system of claim 17, wherein the rendering engine comprises an extensible stylesheet language transformation processor.

21. The system of claim 17, wherein the transport layer is wireless application protocol compliant.

22. The system of claim 17, wherein the dynamic content comprises an extensible mark-up language document corresponding to a view and a view identifier corresponding to the view.

23. The system of claim 22, wherein the view identifier comprises a numerical representation that uniquely identifies the view.

24. The system of claim 23, wherein the view identifier further comprises a view version number.

25. The system of claim 17, wherein the template comprises a template version number.

26. The system of claim 17, wherein the business logic layer extracts information from the wireless client to generate a request for dynamic content.

27. The system of claim 17, wherein the template cache comprises a flat-file data structure.

28. The system of claim 17, wherein the template cache comprises a hash table.

29. The system of claim 17, wherein the view corresponds to a particular screen in a distributed application running on the enterprise server.

30. The system of claim 17, wherein the view is a web view.

31. A method for optimizing wireless data interchange, comprising:
receiving a request for a view;
retrieving a data package corresponding to the view;
transmitting the data package to a wireless client;
determining if a template corresponding to the view is located on the wireless client;
retrieving the template if the template is located on the wireless client; and
rendering the view on the wireless client using the data package and the template.

32. The method of claim 31, further comprising:
issuing an update request for the template if the template is not located on the wireless client;
receiving a response to the update request producing an updated template; and
storing the updated template on the wireless client.

33. The method of claim 32, wherein the update request comprises a request for a template having a template version number matching a view version number located on the data package.

34. The method of claim 31, wherein the step of determining if a template corresponding to the view is present on the wireless client comprises comparing a template version number located on the template to a view version number located on the data package.

35. The method of claim 31, wherein the data package comprises an extensible markup language document.

36. The method of claim 31, wherein the template comprises an extensible stylesheet language document.

37. The method of claim 31, wherein the step of rendering uses an extensible stylesheet language transformation processor.

38. The method of claim 31, wherein the data package comprises an extensible mark-up language document corresponding to the view and a view identifier corresponding to the view.

39. The method of claim 31, wherein the view identifier comprises a numerical representation that uniquely identifies the view.

40. The method of claim 39, wherein the view identifier further comprises a view version number.

41. The method of claim 31, wherein the template comprises a template version number.

42. The method of claim 31, wherein the view is a web page.

43. The method of claim 31, wherein the view corresponds to a particular screen in a distributed application running on the enterprise server.

44. A method for optimizing wireless data interchange, comprising:
receiving a request for a view;
retrieving a data package corresponding to the view;
transmitting the data package to a wireless client;
determining if a template corresponding to the view is located on the wireless client;
retrieving the template if the template is located on the wireless client;
rendering the view on the wireless client using the data package and the template;
issuing an update request for the template if the template is not present on the wireless client;
receiving a response to the update request producing an updated template; and
storing the updated template on the wireless client.

45. An apparatus for optimizing wireless data interchange, comprising:
means for receiving a request for a view;
means for retrieving a data package corresponding to the view;
means for transmitting the data package to a wireless client;
means for determining if a template corresponding to the view is located on the wireless client;
means for retrieving the template if the template is located on the wireless client; and
means for rendering the view on the wireless client using the data package and the template.

46. An apparatus for optimizing wireless data interchange, comprising:
means for receiving a request for a view;
means for retrieving a data package corresponding to the view;
means for transmitting the data package to a wireless client;
means for determining if a template corresponding to the view is located on the wireless client;
means for retrieving the template if the template is located on the wireless client;
means for rendering the view on the wireless client using the data package and the template;
means for issuing an update request for the template if the template is not present on the wireless client;
means for receiving a response to the update request producing an updated template; and
means for storing the updated template on the wireless client.
